(19) United States
(12) Patent Application Publication
(10) Pub. No.: US 2018/0311527 A1
(43) Pub. Date: Nov. 1, 2018

(54) ALIGNMENT BELT AND METHOD OF USING

(71) Applicant: Alan Ray Owens, Oklahoma City, OK (US)

(72) Inventor: Alan Ray Owens, Oklahoma City, OK (US)

(21) Appl. No.: 15/963,472

(22) Filed: Apr. 26, 2018

Related U.S. Application Data
(60) Provisional application No. 62/490,129, filed on Apr. 26, 2017.

(51) Int. Cl. A63B 21/00; A61H 1/02

(52) U.S. Cl. CPC A63B 21/4001; A61H 1/02; A61H 2201/165; A61H 2201/1628; A63B 21/4035

(57) ABSTRACT

An alignment belt has a main strap and a removable handle for positioning the strap about a person's pelvic region to more readily stretch specific areas of the body to remove stress from muscle, ligaments, tendons and connective tissue. In addition, methods of using and manufacturing the alignment belt are also disclosed.

### CROSS REFERENCE TO RELATED APPLICATIONS/INCORPORATION BY REFERENCE STATEMENT

This application claims priority to U.S. Provisional Application No. 62/490,129 filed Apr. 26, 2017, the content of which is hereby expressly incorporated herein in its entirety.

### BACKGROUND OF THE PRESENTLY DISCLOSED INVENTIVE CONCEPTS

### 1. Field of the Presently Disclosed and/or Claimed Inventive Concepts

The presently disclosed inventive concept(s) relates generally to physical therapy devices and, more particularly, but not by way of limitation, to a belt for assisting a practitioner in stretching and aligning a patient's body.

### 2. Brief Description of Related Art

It is well known that injuries and poor posture can result in serious pain, stiffness, and loss of motion, particularly in the lumbar region of the spine. Physical therapy, chiropractic therapy, and body alignment therapy are commonly used to restore and maintain the body's function and movement. For example, body alignment therapy can be used to stretch specific areas of the body to remove stress from muscle, ligaments, tendons and connective tissue so that wear and tear is reduced and tensions and pain disappear.

Some stretches can be difficult for a practitioner to perform on a patient without causing muscle tension and pain to the practitioner. To this end, a need exists for a device that can assist the practitioner in manipulating a patient's body without causing undue stress on the practitioner's own body. It is to such devices, methods of making, and methods of using such devices that the inventive concepts disclosed herein are directed.

### SUMMARY OF THE DISCLOSURE

The inventive concepts disclosed and claimed herein relate generally to a belt for assisting a practitioner in stretching and aligning a patient's body. The belt has a main strap and a removeable handle. The main strap is positionable and tightenable about a patient's body. The removable handle is engageable with the main strap and includes a handle grip.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a perspective view of one embodiment of an alignment belt constructed in accordance with the presently disclosed inventive concept(s).

FIG. 2 is a diagram of the inside of the alignment belt of FIG. 1.

FIG. 3 is a diagram of the outside of the alignment belt of FIG. 1.

FIG. 4 is a perspective view of a portion of an exemplary removable handle.

FIG. 5 is a perspective view of an exemplary handle grip that can be used with the removable handle portion of FIG. 4.

FIG. 6 is a photograph of a practitioner pulling the handle of the alignment belt positioned about a person's hips.

FIG. 7 is a photograph of the practitioner using the alignment belt in FIG. 6 to stretch the hip area of the person in FIG. 6.

FIG. 8 is a photograph of the practitioner using the alignment belt in FIG. 6 to stretch the lumbar region of the person in FIG. 6.

### DETAILED DESCRIPTION

Before explaining at least one embodiment of the presently disclosed inventive concept(s) in detail, it is to be understood that the presently disclosed inventive concept(s) is not limited in its application to the details of construction and the arrangement of the components or steps or methodologies set forth in the following description or illustrated in the drawings. The presently disclosed inventive concept(s) is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the presently disclosed inventive concept(s) shall have the meanings that are commonly understood by those of ordinary skill in the art. Further, unless otherwise required by context, singular terms shall include pluralities and plural terms shall include the singular.

All of the articles and/or methods disclosed herein can be made and executed without undue experimentation in light of the present disclosure. While the articles and methods of the presently disclosed inventive concept(s) have been described in terms of preferred embodiments, it will be apparent to those of skill in the art that variations may be applied to the articles and/or methods and in the steps or in the sequence of steps of the method described herein without departing from the concept, spirit, and scope of the presently disclosed inventive concept(s). All such similar substitutes and modifications apparent to those skilled in the art are deemed to be within the spirit, scope, and concept of the presently disclosed inventive concept(s).

As utilized in accordance with the present disclosure, the following terms, unless otherwise indicated, shall be understood to have the following meanings:

The use of the word “a” or “an” when used in conjunction with the term “comprising” in the claims and/or the specification may mean “one”, but it is also consistent with the meaning of “one or more,” “at least one,” and “one or more than one.” The use of the term “or” in the claims is used to mean “and/or” unless explicitly indicated to refer to alternatives only or that the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects. For example, but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent. The use of the term “at least one of X, Y, and Z” will be understood to include X alone, Y alone, and Z alone, as well as any combination of X, Y, and Z. The use of ordinal number terminology (i.e., “first,” “second,” “third,” “fourth,” etc.) is solely for the purpose of differentiating between two or more items and is not meant to imply any sequence or order or importance to one item over another or any order of addition, for example.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

As used herein, the term “substantially” means that the subsequently described event or circumstance completely occurs or that the subsequently described event or circumstance occurs to a great extent or degree. For example, when associated with a particular event or circumstance, the term “substantially” means that the subsequently described event or circumstance occurs at least 80% of the time, or at least 85% of the time, or at least 90% of the time, or at least 95% of the time. The term “substantially adjacent” may mean that two items are 100% adjacent to one another, or that the two items are within close proximity to one another but not 100% adjacent to one another, or that a portion of one of the two items is not 100% adjacent to the other item but is within close proximity to the other item.

The term “associate” as used herein will be understood to refer to the direct or indirect connection of two or more items.

As discussed above, some therapeutic body stretches can be difficult for the practitioner to perform on a routine basis without causing muscle tension and pain to him/herself. For example, a lumbar stretch requires reaching around a patient's lower hip with one arm, pulling the lower hip up and toward oneself, while pushing down and away on the patient's waist or upper hip with the other arm. This can cause significant stress on the practitioner's back, particularly if the patient is large or heavy.

Turning now to the presently disclosed inventive concept(s), certain embodiments thereof are directed to therapeutic devices such an alignment belt that can be wrapped about a patient's body and used by a practitioner to stretch that portion of the body to relieve tension and pain.

Certain other embodiments of the presently disclosed inventive concept(s) are directed to methods of making and use of the above alignment belt.

The presently disclosed inventive concept(s) possesses many benefits over the prior art. First, the alignment belts disclosed or otherwise contemplated herein aid in stretching specific areas of the patient's body. In addition, the alignment belts disclosed or otherwise contemplated herein allow a practitioner to stretch the patient's body to relieve tension and pain without additionally causing muscle tension and pain to the practitioner. Therefore, the alignment belts disclosed or otherwise contemplated herein assist the practitioner in providing a strong, even stretch to the patient at significantly less stress to the practitioner. Certain embodiments of the presently disclosed inventive concept(s) will be described herein below with reference to the Drawings.

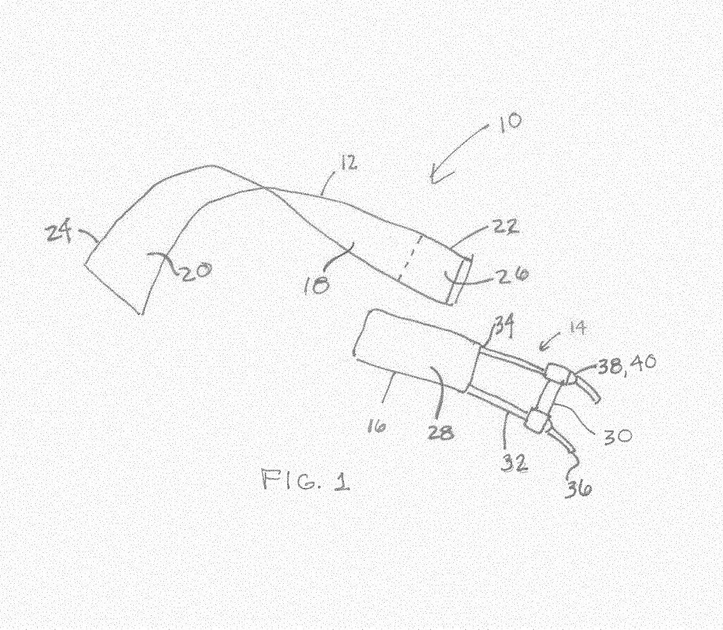

Referring now to FIG. 1, shown therein is an embodiment of an alignment belt constructed in accordance with the presently disclosed inventive concept(s). The alignment belt 10 includes a main strap 12 and a removable handle 14 having an handle attachment tab 16. The main strap 12 is positionable and tightenable about a patient's body. The removable handle 14 can be readily attached to the main strap 12 at any desired position. Once the alignment belt 10 is positioned and tightened about the patient's body and the removable handle 14 positioned on the main strap 12, the practitioner can pull on the removable handle 14 to stretch or twist the patient's body at a specific location.

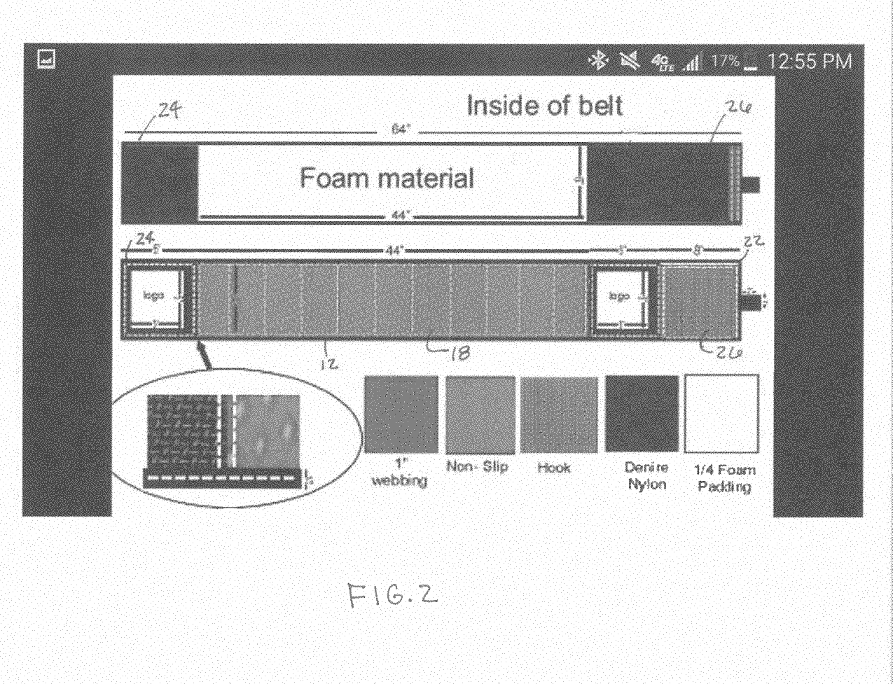

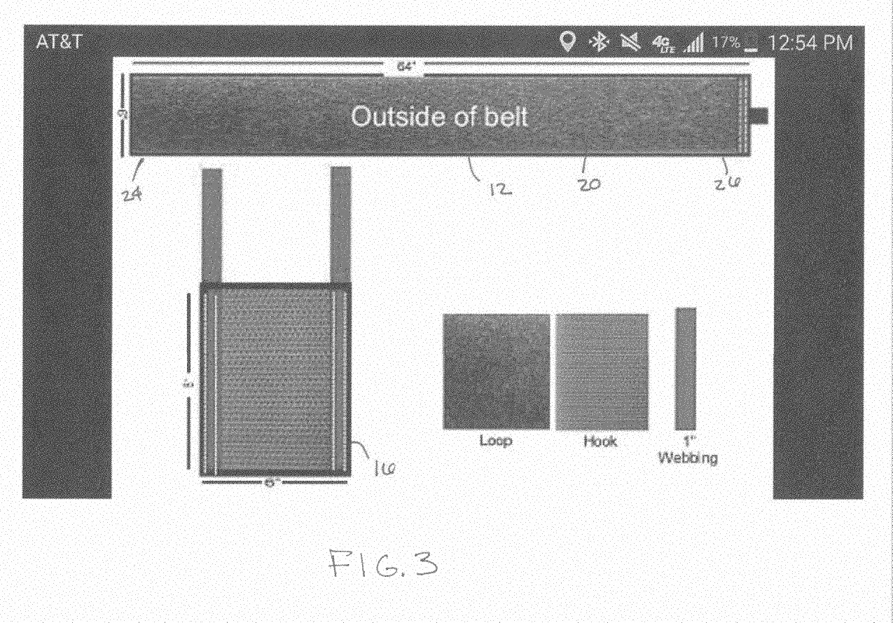

Referring now to FIG. 2 and FIG. 3, the main strap 12 has an inside surface 18 and an outside surface 20. The inside surface 18 contacts the patient's body during use and comprises a slip-resistant material to insure the belt does not readily slip or slide against the patient's body or clothing. Non-limiting examples of suitable slip-resistant materials include amorphous atactic olefin polymers such as an ethylene and propylene copolymer, and copolymers of propylene and a terminally unsaturated olefin, such as 1-butene, 1-hexene, and 1-octene. In one embodiment, the slip resistant character is provided by the texture of the inside surface 18.

In one embodiment, the main strap 12 comprises a first end 22, a second end 24, and a securing portion 26 on the first end 22 of the main strap 12. The securing portion 26 is attachable to and removable from the outside surface 20 of the main strap 12.

In one embodiment, the securing portion 26 releasably engages the outside surface 20 using, e.g., with a hook-and-loop-type fastener, such as Velcro® (e.g., low profile Velcro®). It is appreciated that other adjustable coupling structures may be employed. In one embodiment, the securing portion 26 includes the hook-structure while the outside surface 20 of the main strap 12 includes the loop structure.

In one embodiment, the removable handle 14 also uses a hook-and-loop-type fastener, such as Velcro®, to releasable attach to the outside surface 20 of the main strap 12. For example, the handle attachment tab 16 can include a securing surface 28 having a Velcro®-type hook structure for releasable attaching to a Velcro®-type loop structure on the outside surface 20 of the main strap 12.

In one embodiment, a cushion material such as foam is included in at least a portion of the main strap 12. The cushion material or foam can be sandwiched between a slip resistant material providing the inside surface 18 and a securable material providing the outside surface 20.

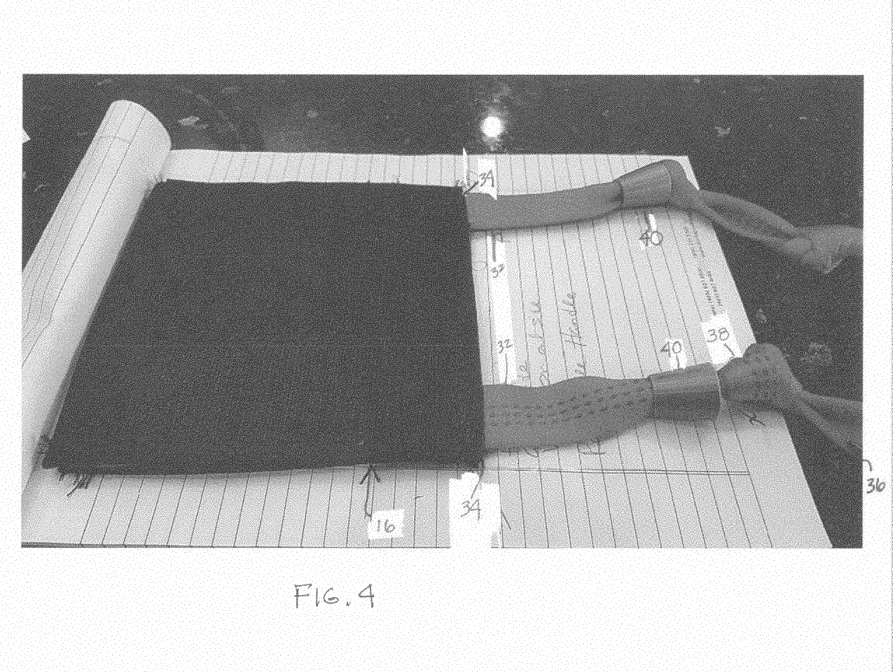

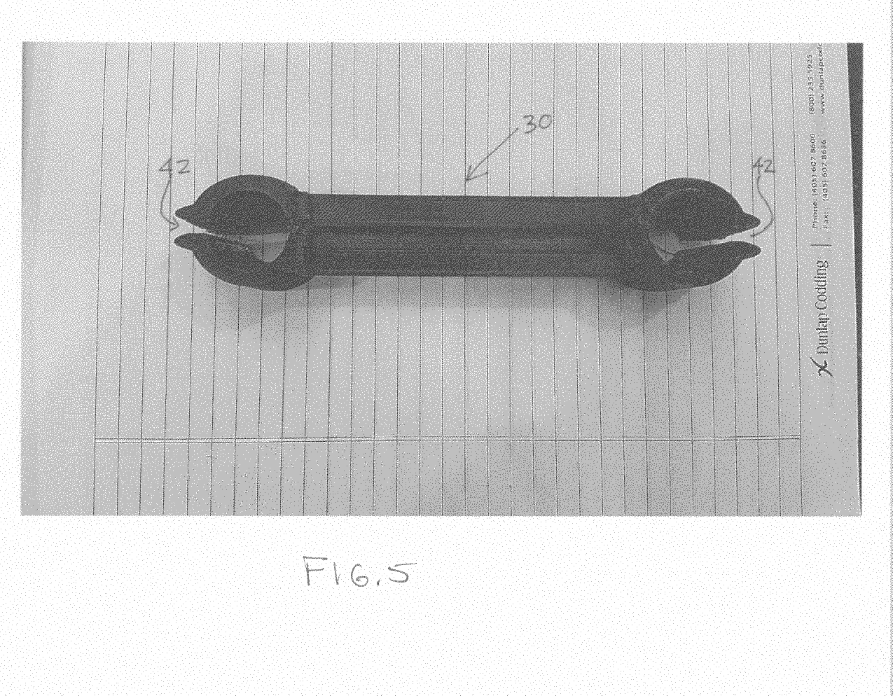

Referring to FIG. 1 and FIG. 4, in one embodiment, the removable handle 14 further includes a handle grip 30 slidably connected to strips 32. The strips 32 attach to the handle attachment tab 16 at strip attachment ends 34. The handle grip 30 is prevented from sliding off the strip terminal ends 36 by knots 38 in the strips 32, each knot 38 holding a hollow shell 40. The hollow shell 40 is conical and fits over the knot 38. The handle grip 30 includes slotted orifices 42 (see FIG. 5) for receiving the strips 32. The slotted orifices 42 are sized to also receive and be stopped by the shells 40. The position of the handle grip 30 can be adjusted by untying the knots 38 and retying them at a different desired position along the strips 32.

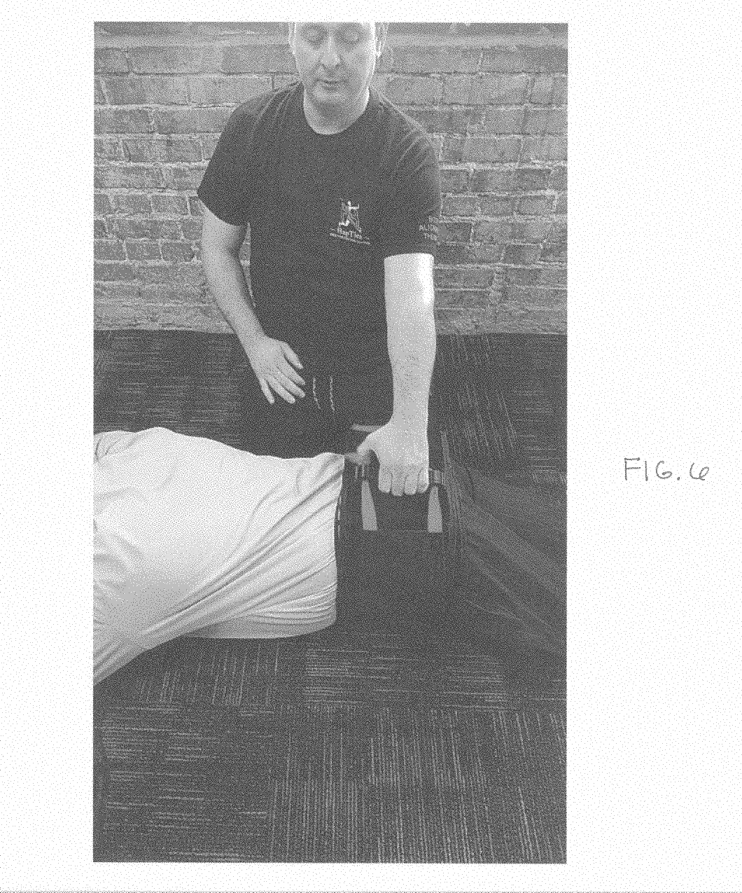

In one embodiment, the alignment belt 10 is used by wrapping the belt about a person's hips and positioning the person on a table or floor as shown in FIG. 6. The handle attachment tab is positioned partly under the person's hip. The alignment belt allows a practitioner or other second person, to remain in an essentially upright position while pulling the handle to twist and thereby stretch the back area adjacent the hip. This manipulation stretches the person's connective tissue in nearly the same manner as can be seen from the person's shirt in FIG. 6. Further, there is no need for the practitioner or other second person to risk straining his or her own back by reaching around the hip while pulling.

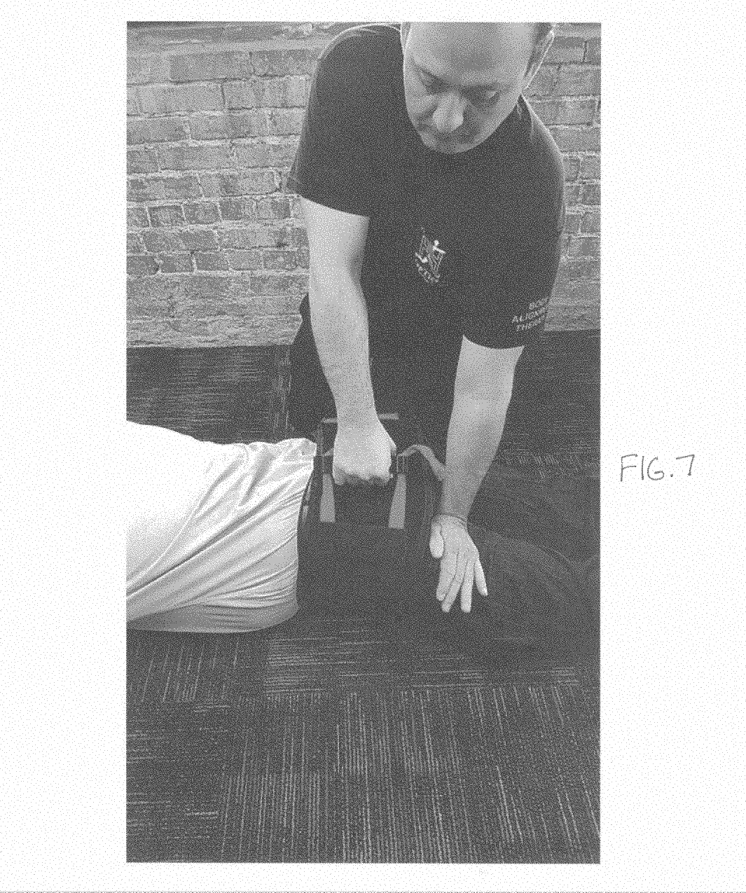

Using the alignment belt positioned as in FIG. 6, the practitioner can pull on the handle with one hand while pushing down on the glute with the other hand as shown in FIG. 7. This stretches the muscle, ligaments, tendons and connective tissue to correct anterior pelvic tilt (APT) and leg length issues.

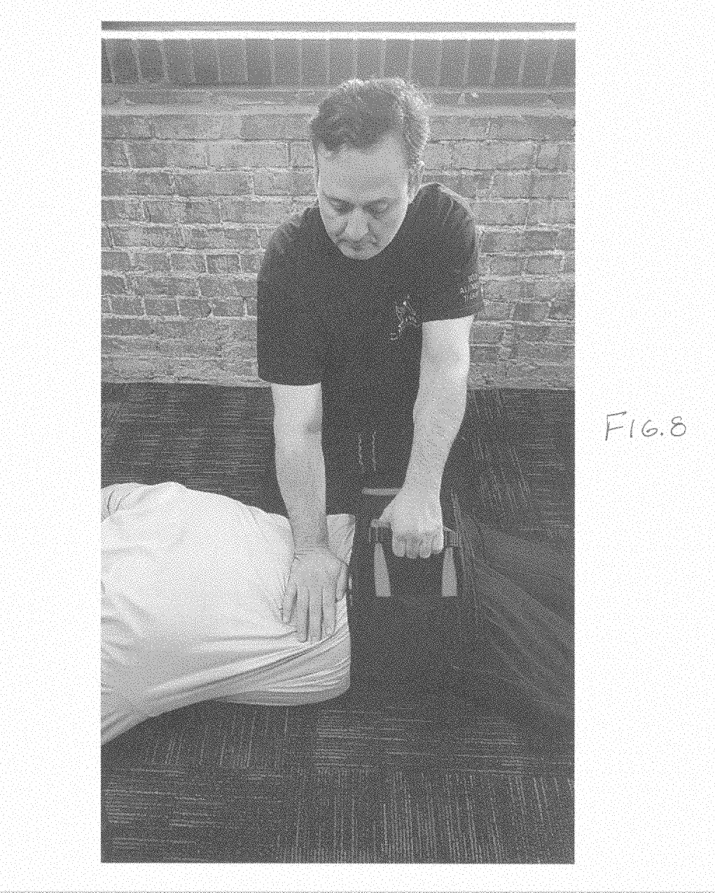

Using the alignment belt positioned as in FIG. 6, the practitioner can also pull on the handle with one hand while pushing against the lower lumbar region with the other hand as shown in FIG. 8. This stretches the muscle, ligaments, tendons and connective tissue in the lower lumbar region thereby relieving tension, muscle soreness, and pain generally. This manipulation offers both force and counter force to get the desired stretch creating more range of motion and movement for the person treated.

Suitable examples of materials and textiles that may be utilized in manufacture of the main strap 12 and handle attachment tab 16 include, but are not limited to, natural fibers such as cotton, silk, wool and linen, and synthetic polymers and copolymers such as nylon, polyester, acrylic, polyolefin, polyurethane and vinyl. Fibers can be woven, knit, and non-woven, or blown to provide a foam for the cushion material.

The handle grip 30 can be manufactured using, for example, injection molding, press-molding, die casting, stamping, machining, 3D printing and the like and combinations thereof. Suitable materials include liquid plastics, polymers, metals, alloys, non-metals, wood, plastics, resins, or combinations thereof.

In general, the alignment belt 10 may be formed in any manner known in the art or otherwise contemplated by a person having ordinary skill in the art, so long as the alignment belt 10 can function in accordance with the presently disclosed inventive concept(s). For example, manufacture of the main strap, attachment tab, and attachment of the strips to the attachment tab can be achieved by sewing, bonding material, mechanical fastening, and other means known or contemplated by those skilled in the art. The term “bonding material” as used herein will be understood to refer to any material that is sufficient to connect two elements to one another; in particular, the term “bonding material” will be understood to refer to any material that is sufficient to connect the strips 32 to the handle attachment tab 16. Examples of bonding materials include, but are not limited to, adhesives (including, but not limited to, pressure-sensitive adhesives and cold seal adhesives), cohesives, adhesive/cohesive combinations, heat sealable materials (such as, but not limited to, heat sealing lacquers or hot melt materials), sonically sealable materials (including, but not limited to, ultrasonically sealable materials), vibratory sealable materials, combinations thereof, and the like. Mechanical fastening includes Methods of forming belts and straps are well known in the art and are well within the knowledge of a person having ordinary skill in the art. Therefore, no further description on the production methods that may be employed for the main strap and handle attachment tab is deemed necessary.

The alignment belt 10 may further include one or more colors, designs, and/or patterns disposed on at least a portion thereof. The color(s), design(s), and/or pattern(s) may include, for example but not by way of limitation, instructions for use, promotional material, company information, logos/trademarks, combinations thereof, and the like. The color(s), design(s) and/or pattern(s) may be disposed on the alignment belt 10 (and/or the material from which the alignment belt 10 is formed) by any method known in the art, including but not limited to, printing, etching, embossing, texturing, coating, lacquering, application during extrusion, and the like. The color(s), design(s) and/or pattern(s) may be applied separately or simultaneously and/or may be characterized totally or partially by pearlescent, translucent, transparent, iridescent, or other similar qualities. Each of the above-named characteristics may occur alone or in combination and may be applied to a portion of the alignment belt 10 and/or the material from which the alignment belt 10 is formed.

Thus, in accordance with the presently disclosed inventive concept(s), there have been provided alignment belts, as well as methods of producing and using the same, that fully satisfy the advantages set forth herein above. Additional drawings of the alignment belt parts and photographs showing use of the alignment belt are appended. Although the presently disclosed inventive concept(s) has been described in conjunction with the specific language set forth herein above, it is evident that many alternatives, modifications, and variations will be apparent to those skilled in the art. Accordingly, it is intended to embrace all such alternatives, modifications, and variations that fall within the spirit and broad scope of the presently disclosed inventive concept(s). Changes may be made in the construction and the operation of the various components, elements, and assemblies described herein, as well as in the steps or the sequence of steps of the methods described herein, without departing from the spirit and scope of the presently disclosed inventive concept(s).

What is claimed is:

1. A belt for assisting a practitioner in stretching and aligning a patient's body, the belt comprising:
a main strap positionable and tightenable about a patient's body; and
a removable handle with a handle grip, the removable handle engageable with the main strap.

2. The belt according to claim 1, wherein the main strap includes a buckle for securing the main strap about the patient's body.

3. The belt according to claim 1, wherein the main strap comprises an inside surface of a slip-resistant material selected from the group consisting of amorphous atactic olefin polymers, copolymers of propylene and a terminally unsaturated olefin, and combinations thereof.

4. The belt according to claim 1, the main strap comprising a first end having a securing portion attachable to and removable from an outside surface of the main strap.

5. The belt according to claim 4, wherein the securing portion releasably engages the outside surface of the main strap using a hook-and-loop type fastener.

6. The belt according to claim 1, the removable handle having a handle attachment tab with strips attached thereto, the handle grip having slotted orifices for receiving the strips, the handle grip thereby slidably connected to the strips and stopped by knots on terminal ends of the strips.

7. The belt according to claim 6, further comprising hollow shells fitted over each knot.

8. The belt according to claim 7, wherein the slotted orifices in the handle grip are sized to be stopped by the hollow shells.
